(19) United States
(12) Patent Application Publication
(10) Pub. No.: US 2026/0161258 A1
(43) Pub. Date: Jun. 11, 2026

(54) TOUCH MODULE AND ELECTRONIC DEVICE

(71) Applicant: Hefei Visionox Technology Co., Ltd., Hefei (CN)

(72) Inventors: Rubo XING, Hefei (CN); Qingrong REN, Hefei (CN); Haijing SHEN, Hefei (CN); Haifeng LU, Hefei (CN)

(73) Assignee: Hefei Visionox Technology Co., Ltd., Hefei (CN)

(21) Appl. No.: 19/178,904

(22) Filed: Apr. 15, 2025

Related U.S. Application Data
(63) Continuation of application No. PCT/CN2023/136580, filed on Dec. 5, 2023.

(30) Foreign Application Priority Data
Jun. 29, 2023 (CN) 202310797794.8

(51) Int. Cl. G06F 3/046; G06F 3/041; G06F 3/044

(52) U.S. Cl. CPC G06F 3/046; G06F 3/04164; G06F 3/0446; G06F 2203/04106; G06F 2203/04111

(57) ABSTRACT

The present application provides a touch module and an electronic device. A touch functional film layer includes a touch electrode. An electromagnetic coil functional film layer includes a first electromagnetic electrode extending along a first direction and a second electromagnetic electrode extending along a second direction. The first direction intersects the second direction. An orthographic projection of at least one of the first electromagnetic electrode and the second electromagnetic electrode on the first insulating layer is staggered from an orthographic projection of the touch electrode on the first insulating layer. By staggering the touch electrode from the electromagnetic electrode, an overlapping area of the touch electrode and the electromagnetic electrode extending in the same direction can be reduced, thereby reducing influence of the electromagnetic electrode on detection progress and load of the touch electrode.

### CROSS-REFERENCE TO RELATED APPLICATIONS

The present application is a continuation of International Application No. PCT/CN2023/136580 filed on Dec. 5, 2023, which claims priority to Chinese Patent Application No. 202310797794.8, entitled “TOUCH MODULE AND ELECTRONIC DEVICE” and filed on Jun. 29, 2023, the entire contents of which are incorporated herein by reference.

### FIELD

The present application relates to the field of display, and in particular to a touch module and an electronic device.

### BACKGROUND

In some electronic devices, to improve handwriting experience, on the basis of arrangement of a capacitive touch detection film layer, an electro magnetic resonance (EMR) detection film layer is further provided to detect an electromagnetic pen. However, an EMR coil electrode may affect detection sensitivity of a touch electrode or a load of the touch electrode.

### SUMMARY

The present application provides a touch module. The touch module includes an electromagnetic coil functional film layer, a first insulating layer, and a touch functional film layer that are stacked. The touch functional film layer includes a touch electrode. The electromagnetic coil functional film layer includes a first electromagnetic electrode extending along a first direction and a second electromagnetic electrode extending along a second direction. The first direction intersects the second direction. An orthographic projection of at least one of the first electromagnetic electrode and the second electromagnetic electrode on the first insulating layer is staggered from an orthographic projection of the touch electrode on the first insulating layer.

The present application further provides an electronic device. The electronic device includes a display panel and the touch module provided in the present application.

### BRIEF DESCRIPTION OF THE DRAWINGS

FIG. 1 is a schematic diagram I of film layers of a touch module according to embodiments of the present application;

FIG. 2 is a schematic diagram I of electrode arrangement of a touch module according to embodiments of the present application;

FIG. 3 is a schematic diagram II of film layers of a touch module according to embodiments of the present application;

FIG. 4 is a schematic diagram III of film layers of a touch module according to embodiments of the present application;

FIG. 5 is a schematic diagram II of electrode arrangement of a touch module according to embodiments of the present application;

FIG. 6 is a schematic diagram IV of film layers of a touch module according to embodiments of the present application;

FIG. 7 is a schematic diagram III of electrode arrangement of a touch module according to embodiments of the present application;

FIG. 8 is a schematic diagram IV of electrode arrangement of a touch module according to embodiments of the present application;

FIG. 9 is a schematic diagram V of electrode arrangement of a touch module according to embodiments of the present application;

FIG. 10 is a schematic diagram VI of electrode arrangement of a touch module according to embodiments of the present application;

FIG. 11 is a schematic diagram VII of electrode arrangement of a touch module according to embodiments of the present application;

FIG. 12 is a schematic diagram VIII of electrode arrangement of a touch module according to embodiments of the present application;

FIG. 13 is a schematic diagram IX of electrode arrangement of a touch module according to embodiments of the present application;

FIG. 14 is a schematic diagram X of electrode arrangement of a touch module according to embodiments of the present application;

FIG. 15 is a schematic diagram XI of electrode arrangement of a touch module according to embodiments of the present application; and

FIG. 16 is a schematic diagram XII of electrode arrangement of a touch module according to embodiments of the present application.

### DETAILED DESCRIPTION

Upon research, the inventors have found that in a touch module provided with an electromagnetic coil, an electromagnetic coil electrode inevitably overlaps with a touch electrode, resulting in signal coupling between the electromagnetic coil electrode and the touch electrode, thereby affecting detection sensitivity of the touch electrode or a load of the touch electrode.

Embodiments of the present application provide solutions that can reduce an influence of the electromagnetic coil on the touch electrode. The solutions provided in the embodiments of the present application will be described in detail below.

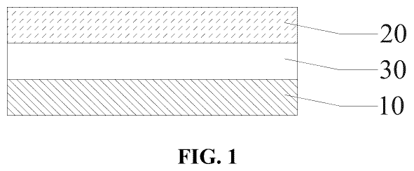

The embodiments of the present application provide a touch module. Referring to FIG. 1, the touch module includes an electromagnetic coil functional film layer 10, a first insulating layer 30, and a touch functional film layer 20 that are stacked.

The touch functional film layer 20 includes a touch electrode. The electromagnetic coil functional film layer 10 includes a first electromagnetic electrode extending along a first direction and a second electromagnetic electrode extending along a second direction. The first direction intersects the second direction.

An orthographic projection of at least one of the first electromagnetic electrode and the second electromagnetic electrode on the first insulating layer 31 is staggered from an orthographic projection of the touch electrode on the first insulating layer 31. That is, the orthographic projection of at least one of the first electromagnetic electrode and the second electromagnetic electrode on the first insulating layer 31 does not completely overlap with the orthographic projection of the touch electrode on the first insulating layer 31.

In this way, by staggering the touch electrode from the electromagnetic electrode, an overlapping area of the touch electrode and the electromagnetic electrode extending in the same direction can be reduced, thereby reducing influence of the electromagnetic electrode on detection progress and load of the touch electrode.

In a possible implementation, the touch electrode may include touch electrode blocks configured to perform self-capacitive touch detection. The orthographic projections of the first electromagnetic electrode extending along the first direction and the second electromagnetic electrode extending along the second direction on the first insulating layer 31 are interlaced to form a mesh structure with gaps. Orthographic projections of the touch electrode blocks on the first insulating layer 31 are located in the gaps and are staggered from the orthographic projections of the first electromagnetic electrode and the second electromagnetic electrode on the first insulating layer 31.

For example, the orthographic projections of the first electromagnetic electrode extending along the first direction and the second electromagnetic electrode extending along the second direction on the first insulating layer 31 are interlaced to form a mesh structure with meshes, and the orthographic projections of the touch electrode blocks on the first insulating layer 31 at least partially overlap with the meshes of the mesh structure.

In another possible implementation, the touch electrode includes a first touch electrode extending along the first direction and a second touch electrode extending along the second direction.

The electromagnetic coil functional film layer includes a first electromagnetic electrode extending along the first direction and a second electromagnetic electrode extending along the second direction. The first direction intersects the second direction.

An orthographic projection of the first touch electrode on the first insulating layer 31 is staggered from the orthographic projection of the first electromagnetic electrode on the first insulating layer 31, and an orthographic projection of the second touch electrode on the first insulating layer 31 is staggered from the orthographic projection of the second electromagnetic electrode on the first insulating layer 31.

That is, the orthographic projection of the first touch electrode on the first insulating layer 31 does not completely overlap with the orthographic projection of the first electromagnetic electrode on the first insulating layer 31, and the orthographic projection of the second touch electrode on the first insulating layer 31 does not completely overlap with the orthographic projection of the second electromagnetic electrode on the first insulating layer 31.

In one embodiment, the orthographic projection of the first touch electrode on the first insulating layer 31 does not overlap at all with the orthographic projection of the first electromagnetic electrode on the first insulating layer 31, and the orthographic projection of the second touch electrode on the first insulating layer 31 does not overlap at all with the orthographic projection of the second electromagnetic electrode on the first insulating layer 31.

In this way, by staggering the touch electrode from the electromagnetic electrode extending in the same direction, an overlapping area of the touch electrode and the electromagnetic electrode extending in the same direction can be reduced, thereby reducing influence of the electromagnetic electrode on detection progress and load of the touch electrode.

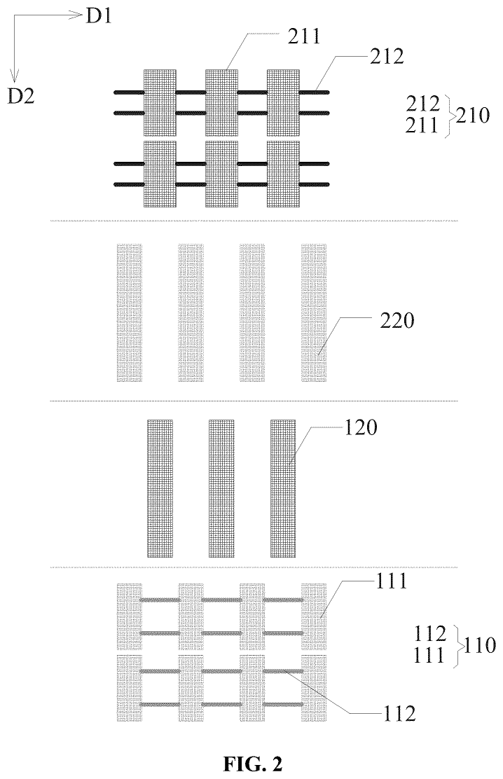

In one embodiment, referring to FIG. 2, second touch electrodes 220 are arranged at intervals along the first direction D1, the first touch electrode 210 includes touch electrode blocks 211 arranged along the first direction D1, and adjacent touch electrode blocks 211 in the same first touch electrode 210 are electrically connected through a second bridging line 212. An orthographic projection of the second bridging line 212 on the first insulating layer 31 at least partially overlaps with the orthographic projection of the second touch electrode 220 on the first insulating layer 31.

Second electromagnetic electrodes 120 are arranged at intervals along the first direction D1, the first electromagnetic electrode 110 includes coil electrode blocks 111 arranged along the first direction D1, and adjacent coil electrode blocks 111 in the same first electromagnetic electrode 110 are electrically connected through a first bridging line 112. An orthographic projection of the first bridging line 112 on the first insulating layer 31 at least partially overlaps with the orthographic projection of the second electromagnetic electrode 120 on the first insulating layer 31.

Further, an orthographic projection of the touch electrode block 211 on the first insulating layer 31 is located between orthographic projections of adjacent second touch electrodes 220 on the first insulating layer 31. The orthographic projection of the second touch electrode 220 on the first insulating layer 31 at least partially overlaps with the orthographic projection of the second bridging line 212 on the first insulating layer 31.

An orthographic projection of the coil electrode block 111 on the first insulating layer 31 is located between orthographic projections of adjacent second electromagnetic electrodes 120 on the first insulating layer 31. The orthographic projection of the second electromagnetic electrode 120 on the first insulating layer 31 at least partially overlaps with the orthographic projection of the first bridging line 112 on the first insulating layer 31.

Correspondingly, the orthographic projection of the touch electrode block 211 on the first insulating layer 31 at least partially overlaps with the orthographic projection of the second electromagnetic electrode 120 on the first insulating layer 31. The orthographic projection of the coil electrode block 111 on the first insulating layer 31 at least partially overlaps with the orthographic projection of the second touch electrode 220 on the first insulating layer 31.

In one embodiment, in the second direction D2, the touch electrode blocks 211 are arranged at intervals, and the orthographic projection of the touch electrode block 211 on the first insulating layer 31 at least partially overlaps with an orthographic projection of the second electromagnetic electrode 120 extending along the second direction D2 on the first insulating layer 31.

In the second direction D2, the coil electrode blocks 111 are arranged at intervals, and the orthographic projection of the coil electrode block 111 on the first insulating layer 31 at least partially overlaps with the orthographic projection of the second touch electrode 220 extending along the second direction D2 on the first insulating layer 31.

Further, the orthographic projection of the coil electrode block 111 on the first insulating layer 31 is located between orthographic projections of two adjacent touch electrode blocks 211 in the first direction D1 on the first insulating layer 31, and the orthographic projection of the touch electrode block 211 on the first insulating layer 31 is also located between orthographic projections of two adjacent coil electrode blocks 111 in the first direction D1 on the first insulating layer.

That is, in the first direction D1, orthographic projections of coil electrode blocks 111 on the first insulating layer 31 and orthographic projections of touch electrode blocks 211 on the first insulating layer 31 are alternately arranged; and in the first direction D1, orthographic projections of second touch electrodes 220 on the first insulating layer 31 and orthographic projections of second electromagnetic electrodes 120 on the first insulating layer 31 are alternately arranged.

On this basis, in some examples, the first touch electrode 210 and the second touch electrode 220 may be located in different touch wiring layers. The first electromagnetic electrode 110 and the second electromagnetic electrode 120 may be located in different coil wiring layers.

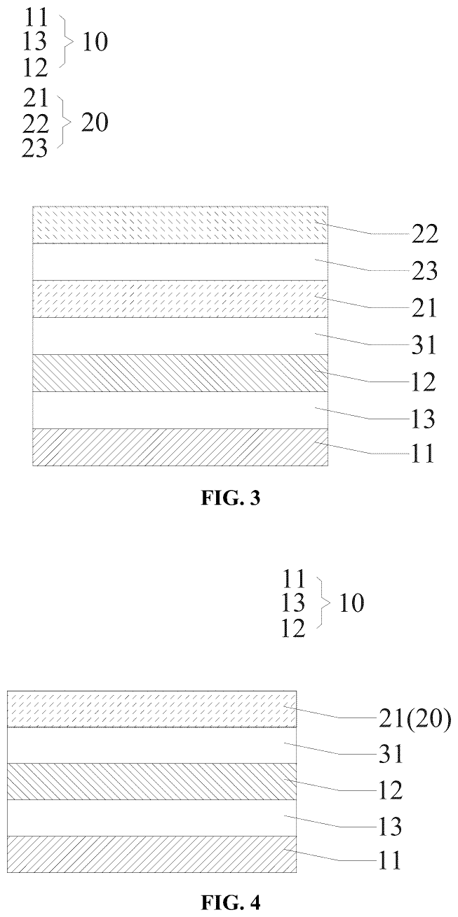

For example, referring to FIG. 3, the electromagnetic coil functional film layer 10 includes a first coil wiring layer 11, a second coil wiring layer 12, and a second insulating layer 13 located between the first coil wiring layer 11 and the second coil wiring layer 12. The touch functional film layer 20 may include a first touch wiring layer 21, a second touch wiring layer 22, and a third insulating layer 23 located between the first touch wiring layer 21 and the second touch wiring layer 22. The first insulating layer 31 may be located between the second coil wiring layer 12 and the first touch wiring layer 21.

The first touch electrode 210 and the second touch electrode 220 may be located in the first touch wiring layer 21 and the second touch wiring layer 22 respectively. The first electromagnetic electrode 110 and the second electromagnetic electrode 120 may be located in the first coil wiring layer 11 and the second coil wiring layer 12 respectively.

In some other examples, the touch electrode block 211 of the first touch electrode 210 and the second touch electrode 220 may be arranged on the same layer. For example, the touch functional film layer includes a first touch wiring layer. The touch electrode block 211 of the first touch electrode 210 and the second touch electrode 220 are located in the first touch wiring layer 21, and the second bridging line 212 is located in a different film layer from the first touch wiring layer. In this way, the first touch electrode 210 and the second touch electrode 220 can be located in the same touch wiring layer, thereby improving mutual capacitance detection performance between the touch electrodes and improving sensitivity of touch detection.

For example, in some examples, referring to FIG. 4, the touch functional film layer 20 includes a first touch wiring layer 21, and the electromagnetic coil functional film layer 10 includes a first coil wiring layer 11, a second coil wiring layer 12, and a second insulating layer 13 located between the first coil wiring layer 11 and the second coil wiring layer 12.

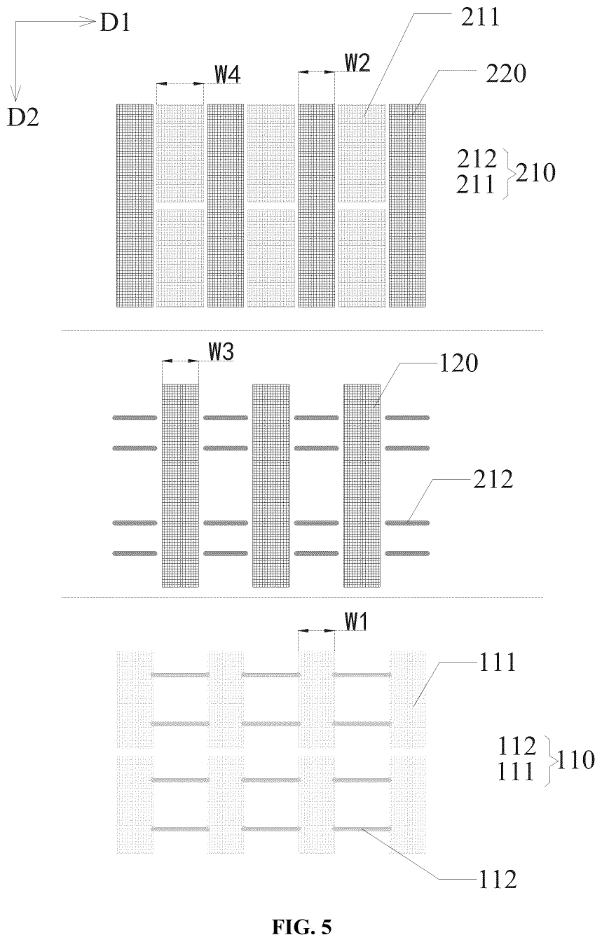

The coil electrode block 111 and the first bridging line 112 are located in the first coil wiring layer 11, and the second electromagnetic electrode 120 and the second bridging line 212 are located in the second coil wiring layer 12, as shown in FIG. 5. In one embodiment, the touch functional film layer 20 is located on a side of the second coil wiring layer 12 away from the first coil wiring layer 11. In this way, the number of overall film layers of the touch module can be reduced, a product thickness can be reduced, and manufacturing efficiency can be improved.

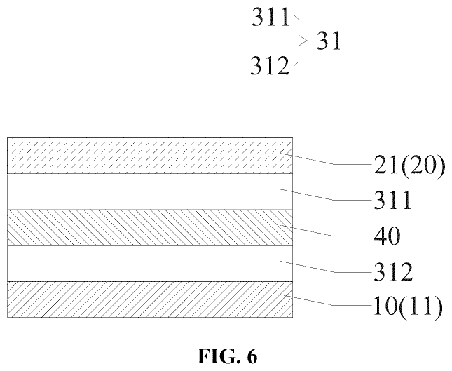

In some other examples, referring to FIG. 6, the touch functional film layer 20 includes a first touch wiring layer 21, and the touch electrode block 211 of the first touch electrode 210 and the second touch electrode 220 are located in the first touch wiring layer 21. The electromagnetic coil functional film layer 10 includes a first coil wiring layer 11, and the coil electrode block 111 of the first electromagnetic electrode 110 and the second electromagnetic electrode 120 are located in the first coil wiring layer 11.

The touch module further includes a bridging wiring layer 40 between the touch functional film layer 20 and the electromagnetic coil functional film layer 10. The first insulating layer 31 includes a first sub-layer 311 located between the bridging wiring layer 40 and the first touch wiring layer 21 and a second sub-layer 312 located between the bridging wiring layer 40 and the first coil wiring layer 11. The first bridging line 112 and the second bridging line 212 are located in the bridging wiring layer. That is, the touch electrode block 211 of the first touch electrode 210 and the second touch electrode 220 are arranged in a same layer, the coil electrode block 111 of the first electromagnetic electrode 110 and the second electromagnetic electrode 120 are arranged in a same layer, and the first bridging line 112 and the second bridging line 212 are arranged in a same layer.

In some embodiments, in order to prevent influence of the electromagnetic electrode on the plate capacitor between the touch electrodes, overlapping of position between the electromagnetic electrode and the touch electrode is required to be prevented.

Referring to FIG. 5 again, a width W1 of the coil electrode block 111 in the first direction D1 is less than a width W2 of the second touch electrode 220 in the first direction D1; and/or a width W3 of the second electromagnetic electrode 120 in the first direction D1 is less than a width W4 of the touch electrode block 211 in the first direction D1.

In one embodiment, in the first direction D1, the orthographic projection of the coil electrode block 111 on the first insulating layer 31 does not exceed the orthographic projection of the second touch electrode 220 on the first insulating layer 31. In the first direction D1, the orthographic projection of the second electromagnetic electrode 120 on the first insulating layer 31 does not exceed the orthographic projection of the touch electrode block 211 on the first insulating layer 31. In this way, overlapping of gaps between the electrode block of the electromagnetic electrode and the electrode block of the touch electrode can be prevented.

In some embodiments, the second electromagnetic electrode 120 and the touch electrode block 211 are formed by grids, and at an overlapping position of the second electromagnetic electrode 120 and the touch electrode block 211, grid density of the second electromagnetic electrode 120 and grid density of the touch electrode block 211 are different. For example, at the overlapping position, the grid density of the second electromagnetic electrode 120 is higher than the grid density of the touch electrode block 211, or the grid density of the second electromagnetic electrode 120 is lower than the grid density of the touch electrode block 211. In this way, an overlapping area of the grids of the second electromagnetic electrode 120 and the grids of the touch electrode block 211 can be reduced, thereby reducing an influence of the second electromagnetic electrode 120 on the first touch electrode 210.

In some embodiments, the coil electrode block 111 and the second touch electrode 220 are formed by grids, and at an overlapping position of the coil electrode block 111 and the second touch electrode 220, grid density of the coil electrode block 111 and grid density of the second touch electrode 220 are different. For example, at the overlapping position, the grid density of the coil electrode block 111 is higher than the grid density of the second touch electrode 220, or the grid density of the coil electrode block 111 is lower than the grid density of the second touch electrode 220. In this way, an overlapping area of the grids of the coil electrode block 111 and the grids of the second touch electrode 220 can be reduced, thereby reducing an influence of the first electromagnetic electrode 110 on the second touch electrode 220.

Further, in some examples, the second electromagnetic electrode 120 includes at least two regions with different grid density, and the touch electrode block 211 includes at least two regions with different grid density.

An orthographic projection of the region with higher grid density of the second electromagnetic electrode 120 on the first insulating layer 31 at least partially overlaps with an orthographic projection of the region with lower grid density of the touch electrode block 211 on the first insulating layer 31, and an orthographic projection of the region with lower grid density of the second electromagnetic electrode 120 on the first insulating layer 31 at least partially overlaps with an orthographic projection of the region with higher grid density of the touch electrode block 211 on the first insulating layer 31.

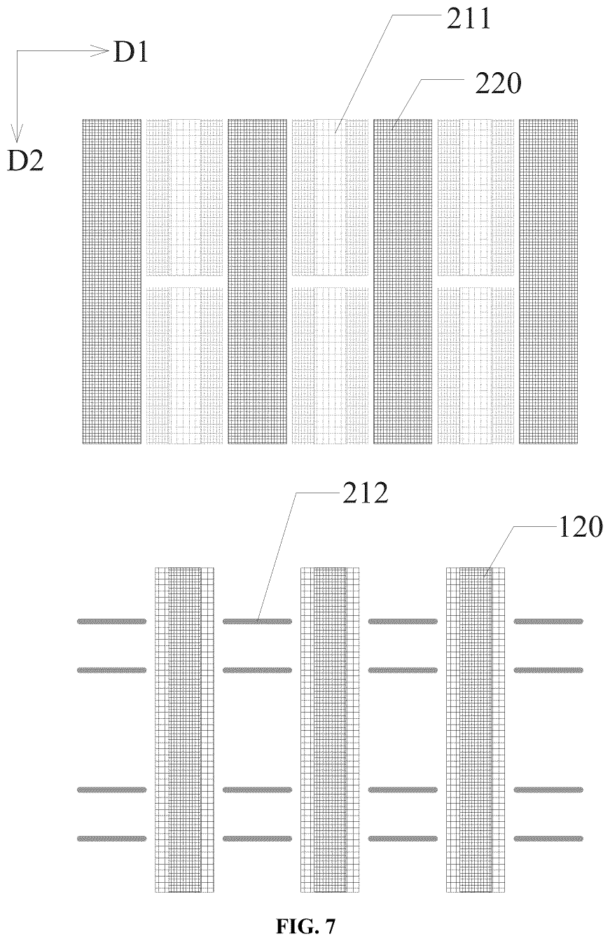

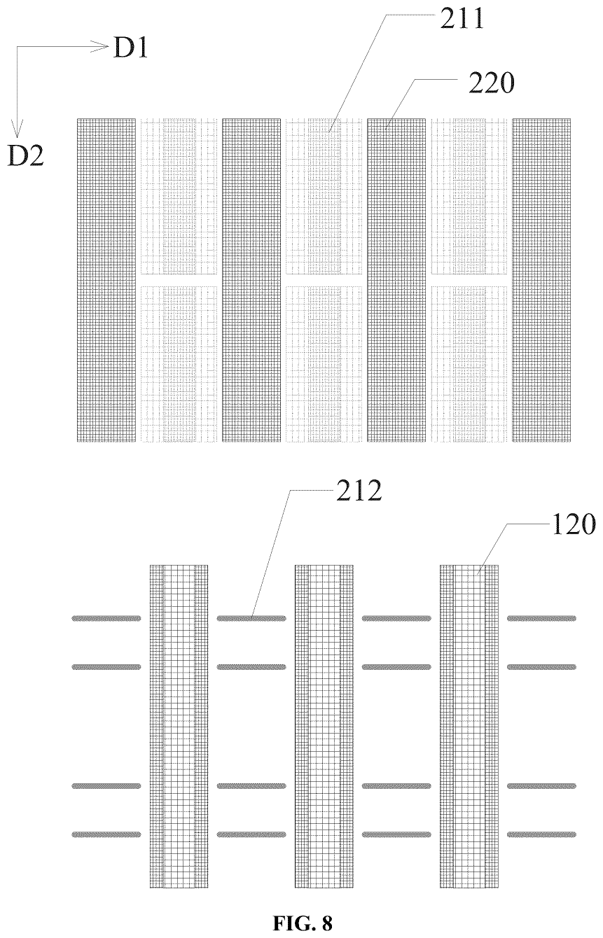

For example, referring to FIG. 7, in the first direction D1, grid density of an intermediate region of the second electromagnetic electrode 120 may be higher than that of two sides, while grid density of an intermediate region of the touch electrode block 211 may be lower than that of two sides. In one embodiment, referring to FIG. 8, in the first direction D1, the grid density of the intermediate region of the second electromagnetic electrode 120 may be lower than that of two sides, while the grid density of the intermediate region of the touch electrode block 211 may be higher than that of two sides.

That is, the position with high grid density of the second electromagnetic electrode 120 overlaps with the position with low grid density of the touch electrode block 211, and the position with low grid density of the second electromagnetic electrode 120 overlaps with the position with high grid density of the touch electrode block 211. In this way, an overlapping area of the grids of the coil electrode block 111 and the grids of the second touch electrode 220 can be reduced, and meanwhile the first electromagnetic electrode 110 and the second touch electrode 220 can be ensured to have a certain proportion of high-density grids, thereby preventing excessively high resistance due to excessive low-density grids.

Further, referring to FIG. 7 again, the region with higher grid density of the touch electrode block 211 is closer to the second touch electrode 220 than the region with lower grid density of the touch electrode block 211. In this way, high-density grids in the first touch electrode 210 is closer to the second touch electrode 220, which can improve sensitivity of mutual capacitance detection between the first touch electrode 210 and the second touch electrode 220.

In some other examples, the coil electrode block 111 includes at least two regions with different grid density, and the second touch electrode 220 includes at least two regions with different grid density.

An orthographic projection of the region with higher grid density of the coil electrode block 111 on the first insulating layer 31 at least partially overlaps with an orthographic projection of the region with lower grid density of the second touch electrode 220 on the first insulating layer 31, and an orthographic projection of the region with lower grid density of the coil electrode block 111 on the first insulating layer 31 at least partially overlaps with an orthographic projection of the region with higher grid density of the second touch electrode 220 on the first insulating layer 31.

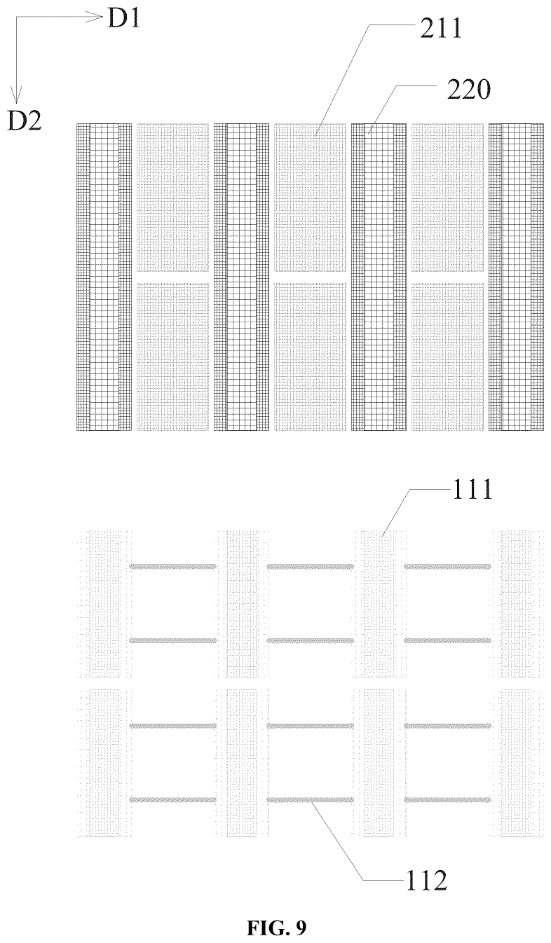

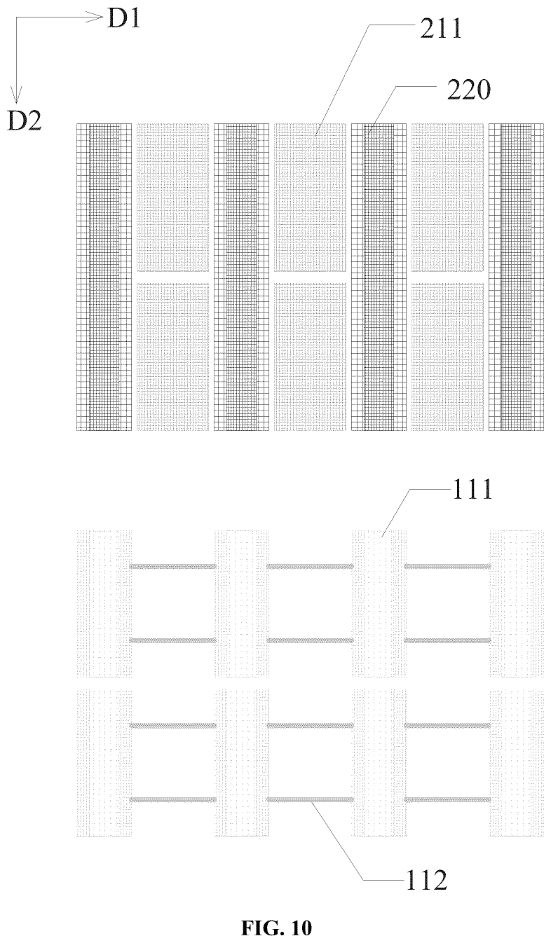

For example, referring to FIG. 9, in the first direction D1, grid density of an intermediate region of the coil electrode block 111 may be higher than that of two sides, while grid density of an intermediate region of the second touch electrode 220 may be lower than that of two sides. In one embodiment, referring to FIG. 10, in the first direction D1, the grid density of the intermediate region of the coil electrode block 111 may be lower than that of two sides, while the grid density of the intermediate region of the second touch electrode 220 may be higher than that of two sides.

That is, the position with high grid density of the coil electrode block 111 overlaps with the position with low grid density of the second touch electrode 220, and the position with low grid density of the coil electrode block 111 overlaps with the position with high grid density of the second touch electrode 220. In this way, an overlapping area of the grids of the coil electrode block 111 and the grids of the second touch electrode 220 can be reduced, and meanwhile the first electromagnetic electrode 110 and the second touch electrode 220 can be ensured to have a certain proportion of high-density grids, thereby preventing excessively high resistance due to excessive low-density grids.

Further, referring to FIG. 9 again, the region with higher grid density of the second touch electrode 220 is closer to the touch electrode block 211 than the region with lower grid density of the second touch electrode 220. In this way, high-density grids of the second touch electrode 220 is closer to the first touch electrode 210, which can improve sensitivity of mutual capacitance detection between the first touch electrode 210 and the second touch electrode 220.

It is to be noted that in the embodiments of the present application, the solutions shown in FIG. 7 and FIG. 8 may be cross-combined with the solutions shown in FIG. 9 and FIG. 10, which are not described in detail in the embodiments of the present application.

In some other examples, the grid density of the second electromagnetic electrode 120 is generally lower than that of the touch electrode block 211; and/or the grid density of the coil electrode block 111 is generally lower than that of the second touch electrode 220. In this way, priority is given to ensuring that the touch electrode has high grid density to ensure accuracy of touch detection.

In some embodiments, a touch surface of the touch module may be rectangular, the first direction D1 may be an extension direction of a short side of the touch module, and the second direction D2 may be an extension direction of a long side of the touch module. In this case, an overall extension length of the second touch electrode 220 extending along the second direction D2 is greater than an overall extension length of the first touch electrode 210 extending along the first direction D1. In order to reduce an overall resistance difference caused by a length difference between the first touch electrode 210 and the second touch electrode 220, in the embodiments of the present application, both the touch electrode block 211 and the second touch electrode 220 may be formed by grids, and grid density of the second touch electrode 220 is higher than that of the touch electrode block.

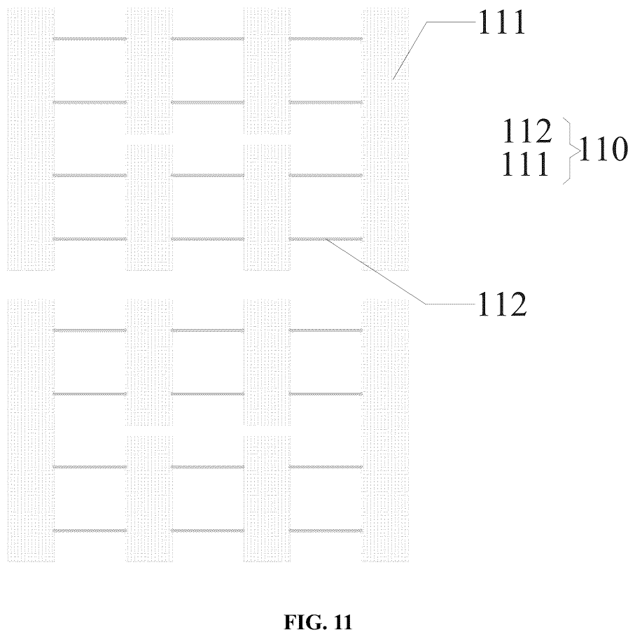

On the basis of the solutions shown in FIG. 2 or FIG. 5, in some embodiments, referring to FIG. 11, two ends of two or more first electromagnetic electrodes 110 may be connected in parallel to form a first electromagnetic electrode group.

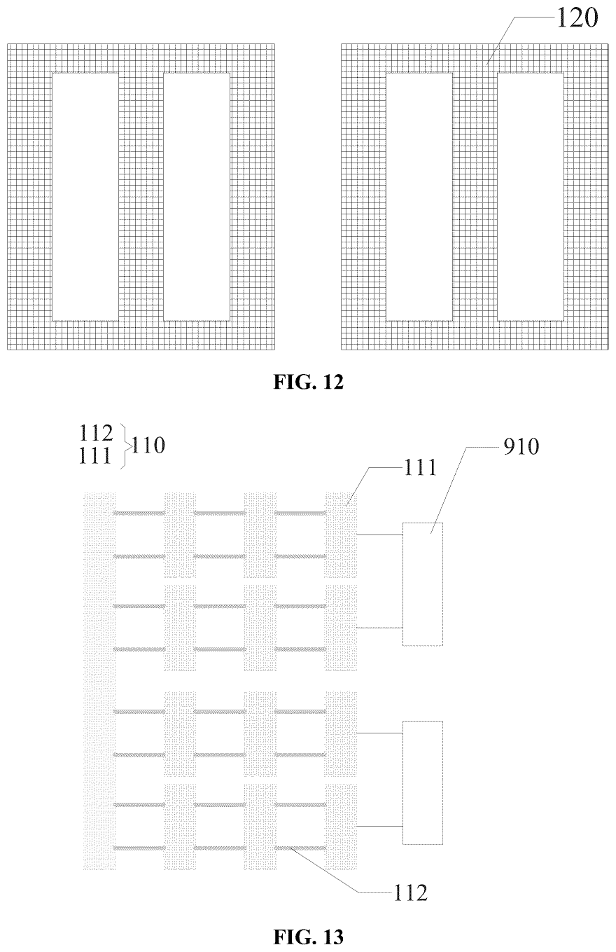

Correspondingly, referring to FIG. 12, two ends of two or more second electromagnetic electrodes 120 may be connected in parallel to form a second electromagnetic electrode group.

In some embodiments, referring to FIG. 13, two adjacent first electromagnetic electrode groups may have one end connected and the other end respectively connected to a first electromagnetic coil detection driving circuit 910 to form a first closed coil detection loop. In addition, ends of the respective first electromagnetic electrodes 110 away from the first electromagnetic coil detection driving circuit 910 may be connected together.

In one embodiment, two ends of three adjacent first electromagnetic electrodes 110 may be connected in parallel respectively to form a first electromagnetic electrode group, and then two adjacent first electromagnetic electrode groups may have one end connected and the other end respectively connected to the first electromagnetic coil detection driving circuit 910, to form a closed coil detection loop.

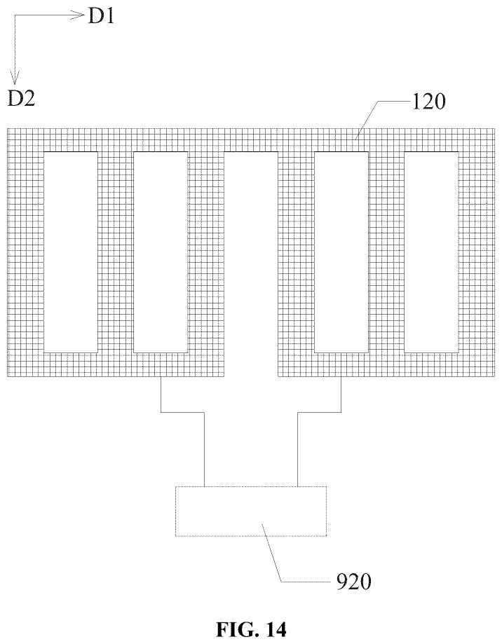

Correspondingly, referring to FIG. 14, two adjacent second electromagnetic electrode groups may have one end connected and the other end respectively connected to a second electromagnetic coil detection driving circuit 920 to form a closed coil detection loop. In addition, ends of the respective second electromagnetic electrodes 120 away from the second electromagnetic coil detection driving circuit 920 may be connected together.

In one embodiment, two ends of three adjacent second electromagnetic electrodes 120 may be connected in parallel respectively to form a second electromagnetic electrode group, and then two adjacent second electromagnetic electrode groups may have one end connected and the other end respectively connected to the second electromagnetic coil detection driving circuit 920, to form a closed coil detection loop.

Embodiments of the present application further provide a touch module. The touch module includes an electromagnetic coil functional film layer 10, a first insulating layer 30, and a touch functional film layer 20 that are stacked.

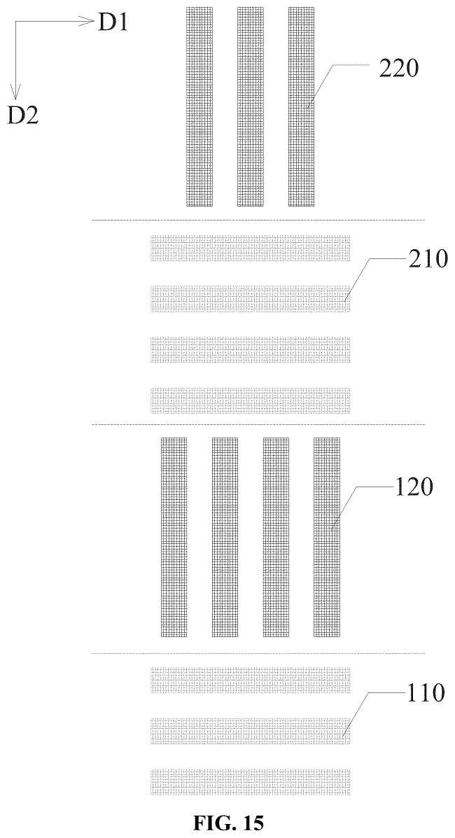

Referring to FIG. 15, the touch functional film layer 20 includes a touch electrode, and the touch electrode includes a strip-shaped first touch electrode 210 extending along the first direction D1 and a strip-shaped second touch electrode 220 extending along the second direction D2. The electromagnetic coil functional film layer 10 includes a strip-shaped first electromagnetic electrode 110 extending along the first direction D1 and a second electromagnetic electrode 120 extending along the second direction D2.

For example, referring to FIG. 3 again, the electromagnetic coil functional film layer 10 may include a first coil wiring layer 11, a second coil wiring layer 12, and a second insulating layer 13 located between the first coil wiring layer 11 and the second coil wiring layer 12. The touch functional film layer 20 may include a first touch wiring layer 21, a second touch wiring layer 22, and a third insulating layer 23 located between the first touch wiring layer 21 and the second touch wiring layer 22. The first insulating layer 31 may be located between the second coil wiring layer 12 and the first touch wiring layer 21.

The electromagnetic coil functional film layer 10 may include a first coil wiring layer 11, a second coil wiring layer 12, and a second insulating layer 13 located between the first coil wiring layer 11 and the second coil wiring layer 12. The touch functional film layer 20 may include a first touch wiring layer 21, a second touch wiring layer 22, and a third insulating layer 23 located between the first touch wiring layer 21 and the second touch wiring layer 22. The first insulating layer 31 may be located between the second coil wiring layer 12 and the first touch wiring layer 21.

The first coil wiring layer 11 may include strip-shaped first electromagnetic electrodes 110 extending along the first direction D1, and the plurality of first electromagnetic electrodes 110 are arranged at intervals. The second coil wiring layer 12 may include strip-shaped second electromagnetic electrodes 120 extending along the second direction D2, and the second electromagnetic electrodes 120 are arranged at intervals.

The first touch wiring layer 21 may include strip-shaped first touch electrodes 210 extending along the first direction D1, and the first touch electrodes 210 are arranged at intervals. The second touch wiring layer 22 may include strip-shaped second touch electrodes 220 extending along the second direction D2, and the second touch electrodes 220 are arranged at intervals.

An orthographic projection of the first touch electrode 210 on the first insulating layer 31 is staggered from an orthographic projection of the first electromagnetic electrode 110 on the first insulating layer 31. For example, the orthographic projection of the first touch electrode 210 on the first insulating layer 31 is located between orthographic projections of adjacent first electromagnetic electrodes 110 on the first insulating layer 31, and the orthographic projection of the first electromagnetic electrode 110 on the first insulating layer 31 is also located between the orthographic projections of adjacent first touch electrodes 210 on the first insulating layer 31.

An orthographic projection of the second touch electrode 220 on the first insulating layer 31 is staggered from an orthographic projection of the second electromagnetic electrode 120 on the first insulating layer 31. For example, the orthographic projection of the second touch electrode 220 on the first insulating layer 31 is located between orthographic projections of adjacent second electromagnetic electrodes 120 on the first insulating layer 31, and the orthographic projection of the second electromagnetic electrode 120 on the first insulating layer 31 is also located between the orthographic projections of adjacent second touch electrodes 220 on the first insulating layer 31.

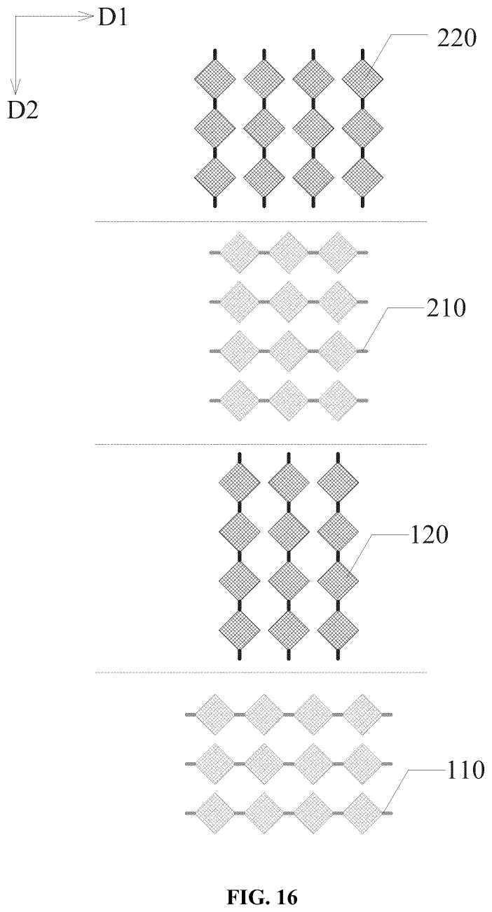

Embodiments of the present application further provide a touch module. Referring to FIG. 16, different from the solution shown in FIG. 15, the first electromagnetic electrode 110, the second electromagnetic electrode 120, the first touch electrode 210, and the second touch electrode 220 may be formed by rhombus-shaped electrode blocks arranged along respective extension directions and connected by bridging lines. An orthographic projection of the electrode block of the first touch electrode 210 on the first insulating layer 31 is located between orthographic projections of electrode blocks of the first electromagnetic electrodes 110 on the first insulating layer 31. An orthographic projection of the electrode block of the second touch electrode 220 on the first insulating layer 31 is located between orthographic projections of electrode blocks of the second electromagnetic electrodes 120 on the first insulating layer 31. The orthographic projection of the electrode block of the first touch electrode 210 on the first insulating layer 31 may overlap with the orthographic projection of the electrode block of the second electromagnetic electrode 120 on the first insulating layer 31. The orthographic projection of the electrode block of the second touch electrode 220 on the first insulating layer 31 may overlap with the orthographic projection of the electrode block of the first electromagnetic electrode 110 on the first insulating layer 31.

On the basis of the solution shown in FIG. 16, in some examples, the first electromagnetic electrode 110 and the second electromagnetic electrode 120 may be located in different coil wiring layers. In one embodiment, the electrode block of the first electromagnetic electrode 110 and the electrode block of the second electromagnetic electrode 120 may be located in the same coil wiring layer, and one of the bridging line of the first electromagnetic electrode 110 and the bridging line of the second electromagnetic electrode 120 may be located in another wiring layer.

On the basis of the solution shown in FIG. 16, in some examples, the first touch electrode 210 and the second touch electrode 220 may be located in different touch wiring layers. In some other examples, the electrode block of the first touch electrode 210 and the electrode block of the second touch electrode 220 may be located in the same touch wiring layer, and one of the bridging line of the first touch electrode 210 and the bridging line of the second touch electrode 220 may be located in another wiring layer.

Further, if the electrode block of the first electromagnetic electrode 110 and the electrode block of the second electromagnetic electrode 120 are located in the same coil wiring layer and the electrode block of the first touch electrode 210 and the electrode block of the second touch electrode are located in the same touch wiring layer, one of the bridging line of the first touch electrode 210 and the bridging line of the second touch electrode 220 may be located in a bridging wiring layer, and one of the bridging line of the first electromagnetic electrode 110 and the bridging line of the second electromagnetic electrode 120 may also be located in the bridging wiring layer.

In some embodiments, in order to prevent influence of the electromagnetic electrode on the plate capacitor between the touch electrodes, overlapping of position between the electromagnetic electrode and the touch electrode is required to be prevented.

In one embodiment, on the basis of the solution shown in FIG. 16, the orthographic projection of the first electromagnetic electrode 110 on the first insulating layer 31 is located within the orthographic projection of the second touch electrode 220 on the first insulating layer 31, and the orthographic projections of the second electromagnetic electrode 120 on the first insulating layer 31 is located within the orthographic projection of the first touch electrode 210 on the first insulating layer 31. That is, the electrode block of the first electromagnetic electrode 110 overlaps with the electrode block of the second touch electrode 220, and an area of the electrode block of the first electromagnetic electrode 110 is smaller than an area of the electrode block of the second touch electrode 220. The electrode block of the second electromagnetic electrode 120 overlaps with the electrode block of the first touch electrode 210, and an area of the electrode block of the second electromagnetic electrode 120 is smaller than an area of the electrode block of the first touch electrode 210. In this way, overlapping of gaps between the electrode block of the electromagnetic electrode and the electrode block of the touch electrode can be prevented.

In some embodiments, on the basis of the solution shown in FIG. 16, grid density at a central position of the electrode block of the first electromagnetic electrode 110 may be lower than that of a peripheral position, while grid density at a central position of the electrode block of the second touch electrode 220 may be higher than that of a peripheral position; or the grid density at the central position of the electrode block of the first electromagnetic electrode 110 may be higher than that of the peripheral position, while the grid density at the central position of the electrode block of the second touch electrode 220 may be lower than that of the peripheral position.

In some examples, grid density at a central position of the electrode block of the second electromagnetic electrode 120 may be lower than that of a peripheral position, while grid density at a central position of the electrode block of the first touch electrode 210 may be higher than that of a peripheral position; or the grid density at the central position of the electrode block of the second electromagnetic electrode 120 may be higher than that of the peripheral position, while the grid density at the central position of the electrode block of the first touch electrode 210 may be lower than that of the peripheral position.

In order to improve sensitivity of mutual capacitance detection between the first touch electrode 210 and the second touch electrode 220, the grid density at the central position of the electrode block of the first touch electrode 210 and/or the electrode block of the second touch electrode 220 may be lower than that of the peripheral position.

Embodiments of the present application further provide an electronic device. The electronic device includes a display panel and the touch module provided in the embodiments of the present application.

In some embodiments, the touch module provided in the embodiments of the present application may be formed on the display panel. For example, after the display panel is manufactured, the electromagnetic coil functional film layer 10, the first insulating layer 31, and the touch functional film layer 20 are sequentially formed on a light exit surface of the display panel. In addition, a protective layer may further be formed on a side of the touch functional film layer 20 away from the display panel. In one embodiment, under a condition that touch detection accuracy of the touch functional film layer 20 is satisfied, after the display panel is manufactured, the touch functional film layer 20, the first insulating layer 31, and the electromagnetic coil functional film layer 10 are sequentially formed on the light exit surface of the display panel. In addition, a protective layer may further be formed on a side of the electromagnetic coil functional film layer 10 away from the display panel.

In some other possible implementations, the touch module provided in the embodiments of the present application may alternatively be manufactured separately and then aligned with and attached to the light exit surface of the display panel. Further, in some examples, to prevent shielding of touch detection induction of the touch functional film layer 20 by the electromagnetic coil functional film layer 10, the touch functional film layer 20 is located on a side away from the display panel relative to the electromagnetic coil functional film layer 10. In some other examples, under a condition that touch detection accuracy of the touch functional film layer 20 is satisfied, the electromagnetic coil functional film layer 10 may be located on a side away from the display panel relative to the touch functional film layer 20.

In some other possible implementations, the electromagnetic coil functional film layer 10 and the first insulating layer 31 may be integrated into the display panel and formed by wiring layers or insulating layers of the array substrate of the display panel, and the touch functional film layer 20 may be formed on the light exit surface of the display panel; or under a condition that touch detection accuracy of the touch functional film layer 20 is satisfied, the touch functional film layer 20 and the first insulating layer 31 may be integrated into the display panel and formed by wiring layers or insulating layers of the array substrate of the display panel, and the electromagnetic coil functional film layer 10 may be formed on the light exit surface of the display panel.

Based on the above, according to the touch module and the electronic device provided in the present application, by staggering the touch electrode from the electromagnetic electrode, an overlapping area of the touch electrode and the electromagnetic electrode extending in the same direction can be reduced, thereby reducing influence of the electromagnetic electrode on detection progress and load of the touch electrode.

The above embodiments may be randomly combined. For concise description, not all possible combinations of the above embodiments are described. However, all the combinations of the embodiments are to be considered as falling within the scope described in this specification provided that they do not conflict with each other.

The above embodiments only describe several implementations of the present application, which are described specifically and in detail, and therefore cannot be construed as a limitation on the scope of the application. It should be pointed out that several changes and improvements can be made without departing from the ideas of the present application, all of which fall within the protection scope of the present application. Therefore, the protection scope of the present application shall be subject to the appended claims.

1. A touch module, comprising:
an electromagnetic coil functional film layer, which includes first electromagnetic electrodes extending along a first direction and second electromagnetic electrodes extending along a second direction, the first direction intersecting the second direction;
a first insulating layer, stacked on the electromagnetic coil functional film layer, and
a touch functional film layer, stacked on the first insulating layer, which includes touch electrodes;
wherein an orthographic projection of at least one of the first electromagnetic electrodes and the second electromagnetic electrodes on the first insulating layer is staggered from an orthographic projection of at least one of the touch electrodes on the first insulating layer.

2. The touch module of claim 1, wherein the touch electrodes include first touch electrodes extending along the first direction and second touch electrodes extending along the second direction;
wherein an orthographic projection of at least one of the first touch electrodes on the first insulating layer is staggered from an orthographic projection of at least one of the first electromagnetic electrodes on the first insulating layer, and an orthographic projection of at least one of the second touch electrodes on the first insulating layer is staggered from an orthographic projection of at least one of the second electromagnetic electrodes on the first insulating layer.

3. The touch module of claim 2, wherein a plurality of the second touch electrodes are arranged at intervals along the first direction; and the first touch electrodes include a plurality of touch electrode blocks arranged along the first direction, adjacent touch electrode blocks in a same first touch electrode are electrically connected with each other through a second bridging line, and an orthographic projection of the second bridging line on the first insulating layer at least partially overlaps with an orthographic projection of at least one of the second touch electrodes on the first insulating layer; and
a plurality of second electromagnetic electrodes are arranged at intervals along the first direction; and the first electromagnetic electrodes includes a plurality of coil electrode blocks arranged along the first direction, adjacent coil electrode blocks in a same first electromagnetic electrode are electrically connected with each other through a first bridging line, and an orthographic projection of the first bridging line on the first insulating layer at least partially overlaps with an orthographic projection of at least one of the second electromagnetic electrodes on the first insulating layer.

4. The touch module of claim 3, wherein an orthographic projection of at least one of the touch electrode blocks on the first insulating layer is located between orthographic projections of adjacent second touch electrodes on the first insulating layer, and an orthographic projection of at least one of the coil electrode blocks on the first insulating layer is located between orthographic projections of adjacent second electromagnetic electrodes on the first insulating layer; or
an orthographic projection of at least one of the touch electrode blocks on the first insulating layer is located between orthographic projections of adjacent two of the coil electrode blocks in the first direction on the first insulating layer, an orthographic projection of at least one of the coil electrode blocks on the first insulating layer is located between orthographic projections of adjacent two of the touch electrode blocks in the first direction on the first insulating layer, an orthographic projection of at least one of the second touch electrodes on the first insulating layer is located between orthographic projections of adjacent two of the second electromagnetic electrodes on the first insulating layer, and an orthographic projection of at least one of the second electromagnetic electrodes on the first insulating layer is located between orthographic projections of adjacent two of the second touch electrodes on the first insulating layer.

5. The touch module of claim 3, wherein the touch functional film layer includes a first touch wiring layer, the touch electrode blocks of the first touch electrodes and the second touch electrodes are located in the first touch wiring layer, and the second bridging line is located in a film layer different from the first touch wiring layer.

6. The touch module of claim 5, wherein the electromagnetic coil functional film layer includes a first coil wiring layer, a second coil wiring layer, and a second insulating layer located between the first coil wiring layer and the second coil wiring layer, and
wherein the coil electrode blocks and the first bridging line are located in the first coil wiring layer, and the second electromagnetic electrodes and the second bridging line are located in the second coil wiring layer, or the touch functional film layer is located on a side of the second coil wiring layer away from the first coil wiring layer; or
the coil electrode blocks of the first electromagnetic electrodes and the second electromagnetic electrodes are located in the first coil wiring layer, and the touch module further includes a bridging wiring layer between the touch functional film layer and the electromagnetic coil functional film layer.

7. The touch module of claim 3, wherein an orthographic projection of at least one of the touch electrode blocks on the first insulating layer at least partially overlaps with an orthographic projection of at least one of the second electromagnetic electrodes on the first insulating layer; and an orthographic projection of at least one of the coil electrode blocks on the first insulating layer at least partially overlaps with an orthographic projection of at least one of the second touch electrodes on the first insulating layer.

8. The touch module of claim 7, wherein in the second direction, the touch electrode blocks are arranged at intervals, and an orthographic projection of at least one of the touch electrode blocks on the first insulating layer at least partially overlaps with an orthographic projection of at least one of the second electromagnetic electrodes extending along the second direction on the first insulating layer; and
in the second direction, the coil electrode blocks are arranged at intervals, and an orthographic projection of at least one of the coil electrode blocks on the first insulating layer at least partially overlaps with an orthographic projection of at least one of the second touch electrodes extending along the second direction on the first insulating layer.

9. The touch module of claim 7, wherein a width of the coil electrode blocks in the first direction is less than a width of the second touch electrodes in the first direction; or a width of the second electromagnetic electrodes in the first direction is less than a width of the touch electrode blocks in the first direction.

10. The touch module of claim 9, wherein in the first direction, an orthographic projection of at least one of the coil electrode block on the first insulating layer does not exceed an orthographic projection of at least one of the second touch electrodes on the first insulating layer; or in the first direction, an orthographic projection of at least one of the second electromagnetic electrodes on the first insulating layer does not exceed an orthographic projection of at least one of the touch electrode blocks on the first insulating layer.

11. The touch module of claim 7, wherein the second electromagnetic electrodes and the touch electrode blocks have a mesh shape and comprise a plurality of grids, and at an overlapping position of the second electromagnetic electrodes and the touch electrode blocks, a grid density of the second electromagnetic electrodes and a grid density of the touch electrode blocks are different; or
the coil electrode blocks and the second touch electrodes have a mesh shape and comprise a plurality of grids, and at an overlapping position of the coil electrode blocks and the second touch electrodes, a grid density of the coil electrode blocks and a grid density of the second touch electrodes are different.

12. The touch module of claim 11, wherein the second electromagnetic electrodes include at least two regions with different grid densities, and the touch electrode blocks include at least two regions with different grid densities; or
the coil electrode blocks include at least two regions with different grid densities, and the second touch electrodes include at least two regions with different grid densities.

13. The touch module of claim 12, wherein the second electromagnetic electrodes include at least two regions with different grid densities, and the touch electrode blocks include at least two regions with different grid densities, and
wherein an orthographic projection of the region with higher grid density of the second electromagnetic electrodes on the first insulating layer at least partially overlaps with an orthographic projection of the region with lower grid density of the touch electrode blocks on the first insulating layer, and an orthographic projection of the region with lower grid density of the second electromagnetic electrodes on the first insulating layer at least partially overlaps with an orthographic projection of the region with higher grid density of the touch electrode blocks on the first insulating layer; or
the region with higher grid density of the touch electrode blocks is closer to the second touch electrodes than the region with lower grid density of the touch electrode blocks.

14. The touch module of claim 12, wherein the coil electrode blocks include at least two regions with different grid densities, the second touch electrodes include at least two regions with different grid densities, an orthographic projection of the region with higher grid density of the coil electrode blocks on the first insulating layer at least partially overlaps with an orthographic projection of the region with lower grid density of the second touch electrodes on the first insulating layer, and an orthographic projection of the region with lower grid density of the coil electrode blocks on the first insulating layer at least partially overlaps with an orthographic projection of the region with higher grid density of the second touch electrodes on the first insulating layer.

15. The touch module of claim 14, wherein the region with higher grid density of the second touch electrodes is closer to the touch electrode blocks than the region with lower grid density of the second touch electrodes.

16. The touch module of claim 11, wherein the grid density of the second electromagnetic electrodes is generally lower than the grid density of the touch electrode blocks; or
the grid density of the coil electrode blocks is generally lower than the grid density of the second touch electrodes.

17. The touch module of claim 3, wherein the touch electrode blocks and the second touch electrodes have a mesh shape and comprise a plurality of grids, and a grid density of the second touch electrodes is higher than a grid density of the touch electrodes block; or
two ends of adjacent two or more of the first electromagnetic electrodes along the second direction are connected in parallel to form a first electromagnetic electrode group, and two adjacent first electromagnetic electrode groups have one end connected and the other end respectively connected to a first electromagnetic coil detection driving circuit to form a first closed coil detection loop; and
two ends of adjacent two or more of the second electromagnetic electrodes along the first direction are connected in parallel to form a second electromagnetic electrode group; and two adjacent second electromagnetic electrode groups have one end connected and the other end respectively connected to a second electromagnetic coil detection driving circuit to form a second closed coil detection loop.

18. The touch module of claim 2, wherein the first electromagnetic electrodes, the second electromagnetic electrodes, the first touch electrodes, and the second touch electrodes are formed by a plurality of rhombus-shaped electrode blocks which are arranged along respective extension directions and connected by bridging lines; an orthographic projection of at least one of the electrode blocks of the first electromagnetic electrodes on the first insulating layer is located within an orthographic projection of at least one of the electrode blocks of the second touch electrodes on the first insulating layer; and an orthographic projection of at least one of the electrode blocks of the second electromagnetic electrodes on the first insulating layer is located within an orthographic projection of at least one of the electrode blocks of the first touch electrodes on the first insulating layer.

19. The touch module of claim 1, wherein the touch electrodes include a plurality of touch electrode blocks configured to perform self-capacitive touch detection, the orthographic projections of the first electromagnetic electrodes and the second electromagnetic electrodes on the first insulating layer are interlaced to form a mesh structure with gaps, and orthographic projections of the touch electrode blocks on the first insulating layer are located in the gaps and are staggered from the orthographic projections of the first electromagnetic electrodes and the second electromagnetic electrodes on the first insulating layer.

20. An electronic device comprising:
a display panel and a touch module, comprising:
an electromagnetic coil functional film layer, which includes first electromagnetic electrodes extending along a first direction and second electromagnetic electrodes extending along a second direction, the first direction intersecting the second direction;
a first insulating layer, stacked on the electromagnetic coil functional film layer, and
a touch functional film layer, stacked on the first insulating layer, which includes touch electrodes;
wherein an orthographic projection of at least one of the first electromagnetic electrodes and the second electromagnetic electrodes on the first insulating layer is staggered from an orthographic projection of at least one of the touch electrodes on the first insulating layer.
